(19) United States
(12) Patent Application Publication
(10) Pub. No.: US 2023/0124027 A1
(43) Pub. Date: Apr. 20, 2023

(54) SYSTEMS AND METHODS FOR CAPTURING IMAGES FOR USE IN ARTIFICIAL INTELLIGENCE PROCESSES IN A LAUNDRY APPLIANCE

(71) Applicant: Haier US Appliance Solutions, Inc., Wilmington, DE (US)

(72) Inventor: Khalid Jamal Mashal, Louisville, KY (US)

(21) Appl. No.: 17/501,263

(22) Filed: Oct. 14, 2021

(51) Int. Cl. H04N 7/18; G06K 9/00; H04L 29/08; H04R 1/08; D06F 34/16; D06F 34/18; D06F 34/28; D06F 34/20; D06F 34/05; G01P 13/00; G01G 19/52

(52) U.S. Cl. CPC H04N 7/188; G06K 9/00624; H04L 67/125; H04R 1/08; D06F 34/16; D06F 34/18; D06F 34/28; D06F 34/20; D06F 34/05; G01P 13/00; G01G 19/52

(57) ABSTRACT

A laundry appliance includes a camera assembly mounted within view of a chamber configured for receiving a load of clothes. A controller is operably coupled to the camera assembly for waking the camera only when certain conditions occur. Specifically, the controller is configured to detect an activity trigger indicative of interaction with the laundry appliance, obtain one or more images of the chamber using the camera assembly in response to detecting the activity trigger, and analyze the one or more images using a machine learning image recognition process to identify the occurrence of a predetermined condition or event.

### FIELD OF THE INVENTION

The present subject matter relates generally to laundry appliances, or more specifically, to systems and methods for activating a camera assembly within a laundry appliance.

### BACKGROUND OF THE INVENTION

Laundry appliances, such as washing machine appliances and dryer appliances, are commonly used to wash and dry, respectively, a load of clothes. Specifically, washing machine appliances generally include a wash tub for containing water or wash fluid and a wash basket rotatably mounted within the wash tub for receiving the load of clothes. These washing machines are typically equipped to operate in one or more modes or cycles, such as wash, rinse, and spin cycles. After the washing machine processes are complete, the load of clothes is moved over to the dryer, which includes a cabinet with a drum rotatably mounted therein and a heating assembly that supplies heated air into a chamber of the drum, e.g., through a duct mounted to a back wall of the drum, to facilitate a drying process.

Certain conventional laundry appliances include cameras for monitoring the chamber of the washer or dryer. These cameras may be programmed to obtain images that are used to improve the operation, safety, or performance of the laundry appliance. For example, these images may be used to detect dangerous conditions, e.g., such as children or other undesirable objects within the chamber. These images may also be analyzed to detect out-of-balance conditions, issues with the water supply, detergent problems, etc. However, conventional laundry appliances obtain many images that provide no useful information that would motivate responsive actions. This data consumes storage space, generates consumer privacy concerns, increases energy usage (e.g., standby power), reduces the camera service life, and is generally inefficient.

Accordingly, a laundry appliance with improved methods of using a camera assembly is desirable. More specifically, a laundry appliance that improves camera utilization for more efficient image capture would be particularly beneficial.

### BRIEF DESCRIPTION OF THE INVENTION

Advantages of the invention will be set forth in part in the following description, or may be apparent from the description, or may be learned through practice of the invention.

In one exemplary embodiment, a laundry appliance is provided including a tub positioned within a cabinet, a basket rotatably mounted within the tub and defining a chamber configured for receiving a load of clothes, a camera assembly mounted within the cabinet in view of the basket, and a controller operably coupled to the camera assembly. The controller is configured to detect an activity trigger indicative of interaction with the laundry appliance, obtain one or more images of the chamber using the camera assembly in response to detecting the activity trigger, and analyze the one or more images using a machine learning image recognition process to identify the occurrence of a predetermined condition or event.

In another exemplary embodiment, a method of operating a laundry appliance is provided. The laundry appliance includes a tub positioned within a cabinet, a basket rotatably mounted within the tub and defining a chamber configured for receiving a load of clothes, and a camera assembly mounted within the cabinet in view of the basket. The method includes detecting an activity trigger indicative of interaction with the laundry appliance, obtaining one or more images of the chamber using the camera assembly in response to detecting the activity trigger, and analyzing the one or more images using a machine learning image recognition process to identify the occurrence of a predetermined condition or event.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary washing machine appliance according to an exemplary embodiment of the present subject matter.

FIG. 2 provides a side cross-sectional view of the exemplary washing machine appliance of FIG. 1.

FIG. 3 provides a cross-sectional view of the exemplary washing machine appliance of FIG. 1 with a camera assembly mounted on a door according to an exemplary embodiment of the present subject matter.

FIG. 4 provides a schematic view of a door and gasket sealed against a cabinet of the exemplary washing machine of FIG. 1, along with a camera mounted within the gasket according to an exemplary embodiment of the present subject matter.

FIG. 5 illustrates a method for operating a laundry appliance in accordance with one embodiment of the present disclosure.

FIG. 6 provides a flow diagram illustrating an exemplary process for activating a camera according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “wash fluid” and the like may be used herein to generally refer to a liquid used for washing and/or rinsing clothing or other articles. For example, the wash fluid is typically made up of water that may include other additives such as detergent, fabric softener, bleach, or other suitable treatments (including combinations thereof). By contrast, the term “water” is intended to refer to water only with no detergent, additives, etc. According to exemplary embodiments, the wash fluid for a wash cycle may be a mixture of water, detergent, and/or other additives, while the wash fluid for a rinse cycle may be water only.

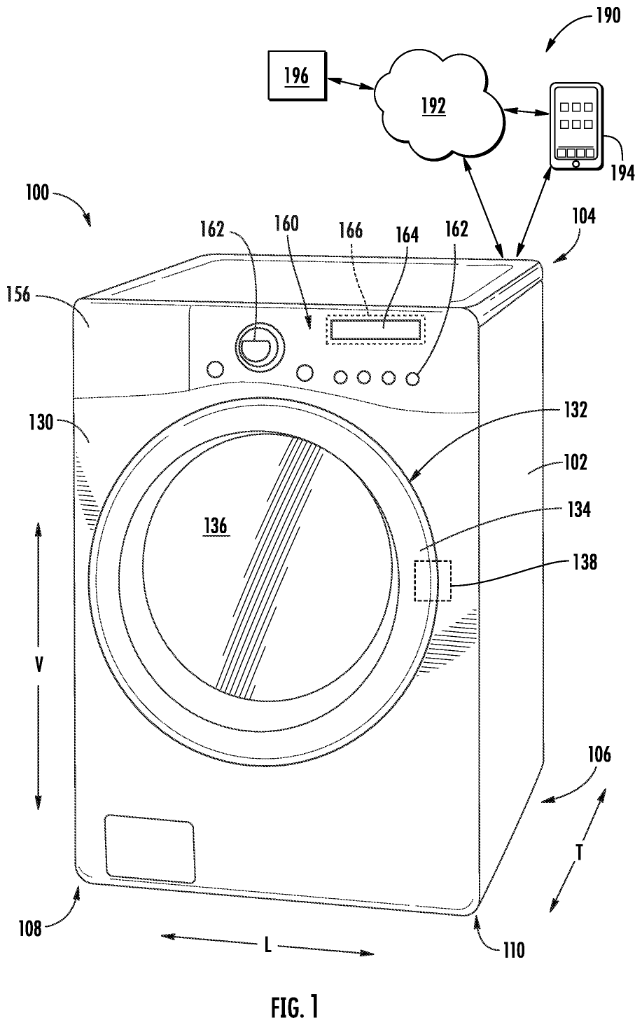

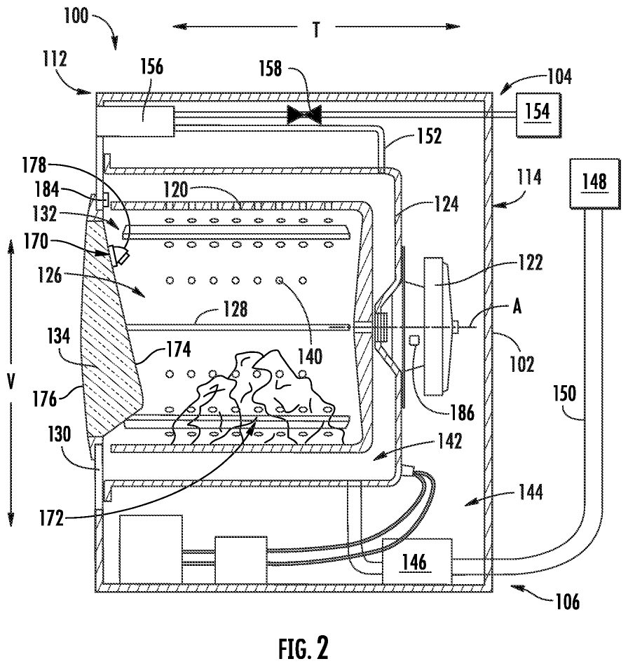

Referring now to the figures, an exemplary laundry appliance that may be used to implement aspects of the present subject matter will be described. Specifically, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIG. 2, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124.

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments. Washing machine appliance 100 may further include a latch assembly 138 (see FIG. 1) that is mounted to cabinet 102 and/or door 134 for selectively locking door 134 in the closed position and/or confirming that the door is in the closed position. Latch assembly 138 may be desirable, for example, to ensure only secured access to wash chamber 126 or to otherwise ensure and verify that door 134 is closed during certain operating cycles or events.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present subject matter.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users. Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through opening 132, and washing operation is initiated through operator manipulation of input selectors 162. Wash tub 124 is filled with water, detergent, and/or other fluid additives, e.g., via spout 152 and/or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

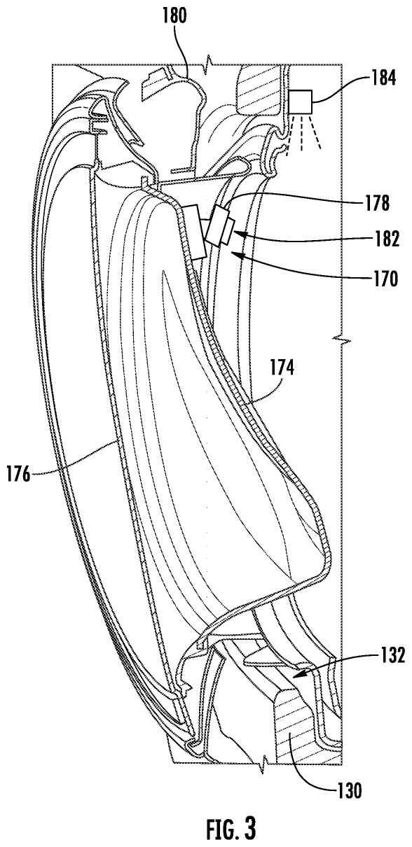

Referring now specifically to FIGS. 2 and 3, washing machine appliance 100 may further include a camera assembly 170 that is generally positioned and configured for obtaining images of wash chamber 126 or a load of clothes (e.g., as identified schematically by reference numeral 172) within wash chamber 126 of washing machine appliance 100. Specifically, according to the illustrated embodiment, door 134 of washing machine appliance 100 comprises and inner window 174 that partially defines wash chamber 126 and an outer window 176 that is exposed to the ambient environment. According to the illustrated exemplary embodiment, camera assembly 170 includes a camera 178 that is mounted to inner window 174. Specifically, camera 178 is mounted such that is faces toward a bottom side of wash tub 124. In this manner, camera 178 can take images or video of an inside of wash chamber 126 and remains unobstructed by windows that may obscure or distort such images.

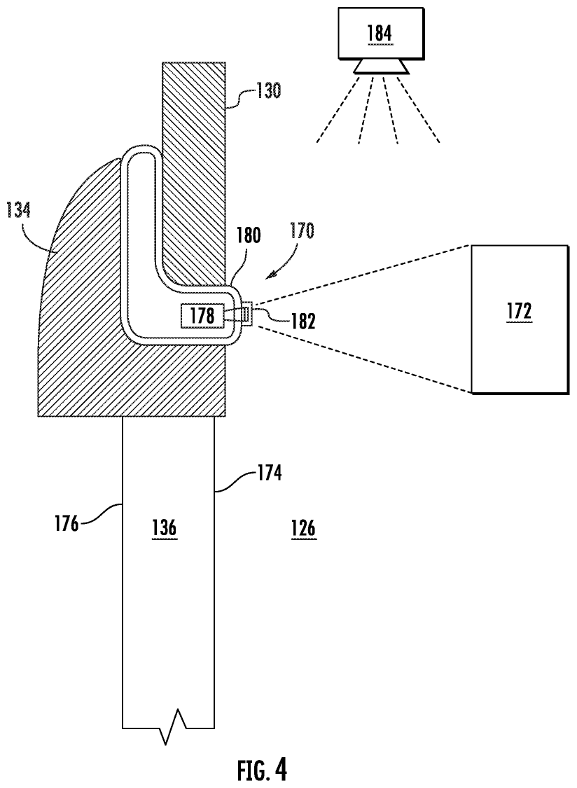

Referring now briefly to FIG. 4, another installation of camera assembly 170 will be described according to an exemplary embodiment of the present subject matter. Due to the similarity between this and other embodiments, like reference numerals may be used to refer to the same or similar features. According to this exemplary embodiment, camera assembly 170 is mounted within a gasket 180 that is positioned between a front panel 130 of cabinet 102 and door 134. Although exemplary camera assemblies 170 are illustrated and described herein, it should be appreciated that according to alternative embodiments, washing machine appliance 100 may include any other camera or system of imaging devices for obtaining images of the load of clothes 172 or wash chamber 126.

It should be appreciated that camera assembly 170 may include any suitable number, type, size, and configuration of camera(s) 178 for obtaining images of wash chamber 126. In general, cameras 178 may include a lens 182 that is constructed from a clear hydrophobic material or which may otherwise be positioned behind a hydrophobic clear lens. So positioned, camera assembly 170 may obtain one or more images or videos of clothes 172 within wash chamber 126, as described in more detail below. Referring still to FIGS. 2 through 4, washing machine appliance 100 may further include a tub light 184 that is positioned within cabinet 102 or wash chamber 126 for selectively illuminating wash chamber 126 and/or the load of clothes 172 positioned therein.

According to exemplary embodiments of the present subject matter, washing machine appliance 100 may further include a basket speed sensor 186 (FIG. 2) that is generally configured for determining a basket speed of wash basket 120. In this regard, for example, basket speed sensor 186 may be an optical, tactile, or electromagnetic speed sensor that measures a motor shaft speed (e.g., such as a tachometer, hall-effect sensor, etc.). According to still other embodiments, basket speeds may be determined by measuring a motor frequency, a back electromotive force (EMF) on motor 122, or a motor shaft speed in any other suitable manner. Accordingly, it should be appreciated that according to exemplary embodiments, a physical basket speed sensor 186 is not needed, as electromotive force and motor frequency may be determined by controller 166 without needing a physical speed sensor. It should be appreciated that other systems and methods for monitoring basket speeds may be used while remaining within the scope of the present subject matter.

Notably, controller 166 of washing machine appliance 100 (or any other suitable dedicated controller) may be communicatively coupled to camera assembly 170, tub light 184, latch assembly 138, and other components of washing machine appliance 100. As explained in more detail below, controller 166 may be programmed or configured for obtaining images using camera assembly 170, e.g., in response to various activity triggers, where the images may be analyzed to detect certain operating conditions and improve the performance of washing machine appliance.

Referring still to FIG. 1, a schematic diagram of an external communication system 190 will be described according to an exemplary embodiment of the present subject matter. In general, external communication system 190 is configured for permitting interaction, data transfer, and other communications with washing machine appliance 100. For example, this communication may be used to provide and receive operating parameters, cycle settings, performance characteristics, user preferences, user notifications, or any other suitable information for improved performance of washing machine appliance 100.

External communication system 190 permits controller 166 of washing machine appliance 100 to communicate with external devices either directly or through a network 192. For example, a consumer may use a consumer device 194 to communicate directly with washing machine appliance 100. For example, consumer devices 194 may be in direct or indirect communication with washing machine appliance 100, e.g., directly through a local area network (LAN), Wi-Fi, Bluetooth, Zigbee, etc. or indirectly through network 192. In general, consumer device 194 may be any suitable device for providing and/or receiving communications or commands from a user. In this regard, consumer device 194 may include, for example, a personal phone, a tablet, a laptop computer, or another mobile device.

In addition, a remote server 196 may be in communication with washing machine appliance 100 and/or consumer device 194 through network 192. In this regard, for example, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g., TCP/IP, HTTP, SMTP, FTP), encodings or formats (e.g., HTML, XML), and/or protection schemes (e.g., VPN, secure HTTP, SSL).

In general, network 192 can be any type of communication network. For example, network 192 can include one or more of a wireless network, a wired network, a personal area network, a local area network, a wide area network, the internet, a cellular network, etc. According to an exemplary embodiment, consumer device 194 may communicate with a remote server 196 over network 192, such as the internet, to provide user inputs, transfer operating parameters or performance characteristics, receive user notifications or instructions, etc. In addition, consumer device 194 and remote server 196 may communicate with washing machine appliance 100 to communicate similar information.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more laundry appliances, other communication protocols and steps may be implemented, etc. These variations and modifications are contemplated as within the scope of the present subject matter.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances. In addition, aspects of the present subject matter may be utilized in a dryer appliance, combination washer/dryer appliance, or other laundry appliances.

Now that the construction of washing machine appliance 100 and the configuration of controller 166 according to exemplary embodiments have been presented, an exemplary method 200 of operating a washing machine appliance will be described. Although the discussion below refers to the exemplary method 200 of operating washing machine appliance 100, one skilled in the art will appreciate that the exemplary method 200 is applicable to the operation of a variety of other washing machine appliances, such as vertical axis washing machine appliances. In exemplary embodiments, the various method steps as disclosed herein may be performed by controller 166 or a separate, dedicated controller.

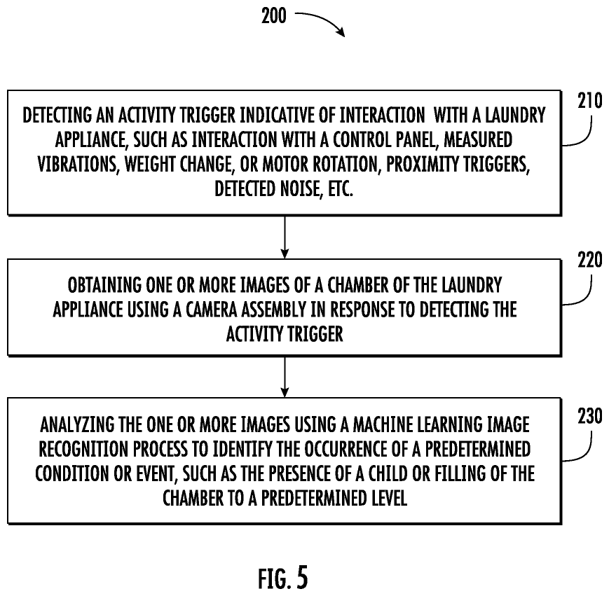

Referring now to FIG. 5, method 200 includes, at step 210, detecting an activity trigger indicative of interaction with a laundry appliance. For example, continuing the example from above, the “activity trigger” may generally refer to various activities or the occurrence of a particular condition or event related to washing machine appliance 100 that may indicate the possibility of a change in the appliance state, surrounding environment, operating conditions, etc. More specifically, this activity trigger may generally indicate the desirability for more detailed appliance monitoring, e.g., such as via a camera assembly 170. In this regard, camera assembly 170 may generally remain in a sleeping or OFF state until the activity trigger is detected, thereby indicating that the camera should be turned on and an image should be taken. In this manner, camera assembly 170 may remain off when not needed, e.g., to conserve energy, increase camera service life, reduce data storage, improving consumer privacy, and generally improve appliance performance and efficiency.

According to exemplary embodiments, the laundry appliance may include a user interface panel and the activity trigger may include any user interaction with the user interface panel. In this regard, for example, if a user of washing machine appliance 100 uses one or more input selectors 162 of control panel 160 (e.g., presses a button, turns a knob, etc.), this may constitute an activity trigger. Similarly, if a user interacts with the appliance via a remote device or control interface, such as remote device 194 through external communication system 190, this may also constitute activity trigger.

According to exemplary embodiment, the activity trigger may also correspond to a change in state or measurement from any suitable sensor or detection device. In this regard, for example, the laundry appliance may include a vibration sensor and detecting the activity trigger may include sensing vibrations using the vibration sensor. For example, the vibration sensor may be one or more of an accelerometer, a gyroscope, or any other suitable vibration detecting device. For example, these vibrations may be associated with the loading of clothes 172 into wash basket 120 or the vibrations may be associated with a child or pet attempting to climb into wash chamber 126, thereby resulting in a safety issue that may be identified using present methods.

According to another exemplary embodiment, the laundry appliance may include a motor and a speed sensor for detecting rotation of the motor. For example, detecting the activity trigger may include determining that the motor is rotating using the motor speed sensor. In this regard, continuing the example from above, controller 166 may use basket speed sensor 186 to determine that wash basket 120 is rotating or has moved, thereby constituting an activity trigger. In addition, according to an exemplary embodiment, a laundry appliance may include a weight sensor and the activity trigger may include a change in weight as measured by the weight sensor.

According to exemplary embodiments, the laundry appliance may also include a door sensor or switch and detecting the activity trigger may include determining that the door has been opened or closed using the door sensor. In this regard, latch assembly 138 may detect that the door 134 has been opened, thereby constituting an activity trigger.

According to another exemplary embodiment, the laundry appliance may further include a microphone and the activity trigger may include detecting a particular noise or volume level using the microphone. In this regard, for example, control panel 160 may include a microphone that is operably coupled with controller 166. Controller 166 may be programmed for detecting a particular sound, frequency, intensity, etc. that may be associated with the occurrence of a particular event. The detection of that sound or sounds may constitute an activity trigger in accordance with the present methods.

According to an exemplary embodiment, the laundry appliance may further include a proximity sensor for detecting the proximity of a person or object coming near the laundry appliance. For example, control panel 160 may include a proximity sensor for detecting when a user, child, parent, or any other object comes near washing machine appliance 100. The detection of such objects coming close to the laundry appliance may constitute the activity trigger. It should be appreciated that these activity triggers are only exemplary and are not intended to limit the scope of the present subject matter in any manner. For example, any other suitable action or event that is detectable by washing machine appliance 100 or by any sensor operably coupled with washing machine appliance 100 may constitute an activity trigger in accordance with aspects of the present subject matter.

Step 220 may include obtaining one or more images of a chamber of the laundry appliance using a camera assembly in response to detecting the activity trigger. In this regard, if step 210 results in the detection of an activity trigger that is associated with interaction with laundry appliance, it may be desirable to activate camera assembly 170 to obtain images. In this regard, for example, camera 178 of camera assembly 170 may be oriented such that it has a field of view that encompasses the load of clothes 172 positioned within wash basket 120. Camera 178 may obtain images at any suitable frequency, resolution, etc. to provide improved knowledge regarding the contents of wash basket 120. As explained below, these images may be used to identify the existence or occurrence of particular conditions or events.

Thus, step 220 includes obtaining one or more images, a series of frames, a video, or any other visual representation of wash basket 120, load of clothes 172 within wash basket 120, or any other objects within the field-of-view of camera 178. For example, camera assembly 170 may obtain a video clip of the load of clothes 172, take a still image from the video clip, or otherwise obtain a still representation or photo from the video clip. It should be appreciated that the images obtained by camera assembly 170 may vary in number, frequency, angle, resolution, detail, etc. in order to improve the clarity of the load of clothes. In addition, according to exemplary embodiments, controller 166 may be configured for illuminating the tub using tub light 184 just prior to obtaining images.

Step 230 may include analyzing the one or more images using a machine learning image recognition process to identify the occurrence of a predetermined condition or event. Although exemplary events are described herein, it should be appreciated that the images being analyzed to identify any suitable event or condition within washing machine appliance 100, such as the presence of child or pet, the level of clothes or wash fluid within the tub, etc. It should be appreciated that this image analysis or processing may be performed locally (e.g., by controller 166) or remotely (e.g., by a remote server).

According to exemplary embodiments of the present subject matter, step 230 of analyzing the one or more images may include analyzing the image(s) using a neural network classification module and/or a machine learning image recognition process. In this regard, for example, controller 166 may be programmed to implement the machine learning image recognition process that includes a neural network trained with a plurality of images of a load of clothes or wash basket in different states, with particular items, etc. By analyzing the image(s) obtained at step 220 using this machine learning image recognition process, controller 166 may determine or approximate the existence of particular conditions or events, e.g., by identifying the trained image that is closest to the obtained image.

As used herein, the terms image recognition process and similar terms may be used generally to refer to any suitable method of observation, analysis, image decomposition, feature extraction, image classification, etc. of one or more images or videos taken within a washing machine appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by camera assembly 170 and controller 166 may be programmed to perform such processes and take corrective action.

According to an exemplary embodiment, controller may implement a form of image recognition called region based convolutional neural network (“R-CNN”) image recognition. Generally speaking, R-CNN may include taking an input image and extracting region proposals that include a potential object, such as a particular region containing a load of clothes and/or an undesirable object within the chamber. In this regard, a “region proposal” may be regions in an image that could belong to a particular object, such as an undesirable object (e.g., a child, pet, etc.). A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like.

According to still other embodiments, the image recognition process may use any other suitable neural network process. For example, step 230 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image determine conditions within the wash tub. In addition, a K-means algorithm may be used. Other image recognition processes are possible and within the scope of the present subject matter.

According to exemplary embodiments the image recognition process may further include the implementation of Vision Transformer (ViT) techniques or models. In this regard, ViT is generally intended to refer to the use of a vision model based on the Transformer architecture originally designed and commonly used for natural language processing or other text-based tasks. For example, ViT represents an input image as a sequence of image patches and directly predicts class labels for the image. This process may be similar to the sequence of word embeddings used when applying the Transformer architecture to text. The ViT model and other image recognition models described herein may be trained using any suitable source of image data in any suitable quantity. Notably, ViT techniques have been demonstrated to outperform many state-of-the-art neural network or artificial intelligence image recognition processes.

It should be appreciated that any other suitable image recognition process may be used while remaining within the scope of the present subject matter. For example, step 230 may include using a deep belief network (“DBN”) image recognition process. A DBN image recognition process may generally include stacking many individual unsupervised networks that use each network's hidden layer as the input for the next layer. According to still other embodiments, step 230 may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence (“AI”) analysis techniques, and combinations of the above described or other known methods may be used while remaining within the scope of the present subject matter.

Method 200 may further include implementing a responsive action in response to identifying the occurrence of the predetermined condition or event. In this regard, for example, the predetermined condition or event may include the presence of a child or pet within wash basket 120. Due to the inherent safety issues involved with the situation, the responsive action may include unlocking the door 134, shutting down washing machine appliance 100, and providing a user notification (e.g., through control panel 160 and/or external communication system 190).

According to still other embodiments, method 200 may facilitate automatic cycle starts when certain conditions occur. For example, identifying the occurrence of the predetermined condition or event may include determining that a clothes level has exceeded the predetermined threshold. In addition, the responsive action may include initiating an operating cycle of the laundry appliance. In this regard, every time a user adds clothes to wash basket 120, a vibration sensor may trigger camera assembly 170 to obtain images. This process may continue until the analysis of such images results in a determination that the load of clothes reaches a predetermined volume or quantity, at which point method 200 may include initiating an operating cycle of washing machine appliance 100.

According to still other embodiments, implementing the responsive action may include adjusting one or more operating parameters of the laundry appliance. For example, the existence of the predetermined condition or event may be associated with a quantity of clothes, the type of clothes, or may otherwise be indicative of the cleaning needs of the clothes added to wash basket 120. Accordingly, the wash fluid temperatures, detergent types, the spin profiles, and other parameters may be adjusted for improved cleaning performance of the clothes added to wash basket 120.

According to still other embodiments, implementing the responsive action may further include providing a user notification that that the predetermined condition or event has occurred. It should be appreciated that the user notification may be provided to the user from any suitable source and in any suitable manner. For example, according to exemplary embodiments, the user notification may be provided through control panel 160 so that the user may be aware of the issue (e.g., such as via an illuminated warning indicator, an image displayed on a screen, etc.). In addition, or alternatively, controller 166 may be configured to provide a user notification to a remote device, such as remote device 194 via a network 192. Whether provided via control panel 160, remote device 194, or by other means, this user notification may include useful information regarding the event or condition. For example, the user notification may include a pop-up notification on a user's cell phone or other remote device and may include a display of the one or more images obtained.

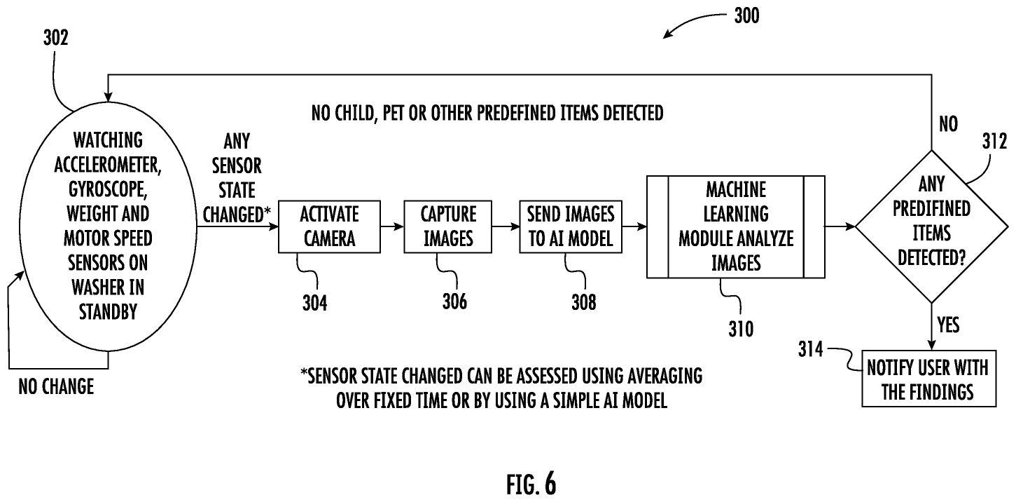

Referring now briefly to FIG. 6, an exemplary flow diagram of a smart camera activation method 300 that may be implemented by washing machine appliance 100 will be described according to an exemplary embodiment of the present subject matter. According to exemplary embodiments, method 300 may be similar to or interchangeable with method 200 and may be implemented by controller 166 of washing machine appliance 100. As shown, at step 302, controller 166 may begin by monitoring one or more sensors while the camera (e.g., such as camera assembly 170) is deactivated and not in the process of obtaining images. In this regard, controller 166 may monitor measurements from an accelerometer, a gyroscope, a weight sensor, a motor speed sensor, a proximity sensor, a microphone, or any other suitable sensor to detect changes in the environment within or surrounding washing machine appliance 100. If any sensor state has changed, step 304 may include activating the camera, and step 306 may include obtaining one or more images or video using the camera.

According to exemplary embodiments, step 308 may include sending the obtained images to an artificial intelligence model or through a machine learning image recognition process that may be performed locally by controller 166 or remotely via external communication system 190. Step 310 may include analyzing the images using a machine learning image recognition model. Step 312 may include determining whether any predefined items (e.g., such as a child or pet) are detected. Alternatively, step 312 may include determining whether a volume of clothes has reached a predetermined cycle start level.

If the predefined items are not detected or if the clothes level has not reached the predetermined cycle start level, the camera may once again be a deactivated and the process may continue back to step 302, where controller 166 monitors various sensors for changes in state or measurements. By contrast, if step 312 results in a determination that there are predefined items detected or that the volume of clothes has reached the preset threshold, responsive action may be implemented at step 314. For example, step 314 may include notifying a user with the findings from step 312.

FIGS. 5 and 6 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 and method 300 are explained using washing machine appliance 100 as an example, it should be appreciated that this method may be applied to the operation of any suitable laundry appliance, such as another washing machine appliance or a dryer appliance.

Aspects of the present subject matter are directed to a laundry appliance with a camera assembly that is automatically activated to obtain images within the appliance upon the detection of various activity triggers. In this regard, when the activity trigger occurs, a smart camera inside a washer may switch from standby to running state and may obtain images that can be analyzed to detect certain conditions or events. For example, when an event outside a wash cycle is detected, such as the opening of the door or interaction with a control panel, images may be obtained and analyzed, and the results of the analysis may be communicated to the user. The analysis uses artificial intelligence techniques to detect changes in status of vibration, motor speed, weight, accelerometer, and/or gyroscope sensors, and based on the change of state of these sensors, a trigger is generated to activate the camera from dormant state. The camera then captures the images of the inside of the wash drum that may be analyzed by the machine learning algorithm. Benefits of activating the camera intermittently (when triggered by sensor) include to save power and for only capturing important events outside a wash cycle to provide notification to users for detecting any predefined items or events.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry appliance, comprising:
a tub positioned within a cabinet;
a basket rotatably mounted within the tub and defining a chamber configured for receiving a load of clothes;
a camera assembly mounted within the cabinet in view of the basket; and
a controller operably coupled to the camera assembly, the controller being configured to:
detect an activity trigger indicative of interaction with the laundry appliance;
obtain one or more images of the chamber using the camera assembly in response to detecting the activity trigger; and
analyze the one or more images using a machine learning image recognition process to identify the occurrence of a predetermined condition or event.

2. The laundry appliance of claim 1, wherein the laundry appliance further comprises a user interface panel, and wherein the activity trigger comprises user interaction with the user interface panel.

3. The laundry appliance of claim 1, wherein the laundry appliance further comprises a vibration sensor, and wherein detecting the activity trigger comprises sensing vibrations using the vibration sensor.

4. The laundry appliance of claim 3, wherein the vibration sensor comprises at least one of an accelerometer or a gyroscope.

5. The laundry appliance of claim 1, wherein the laundry appliance further comprises a motor assembly operably coupled to the basket for selectively rotating the basket and a motor speed sensor, and wherein detecting the activity trigger comprises determining that the motor assembly is rotating using the motor speed sensor.

6. The laundry appliance of claim 1, wherein the laundry appliance further comprises a weight sensor, and wherein detecting the activity trigger comprises detecting a change in weight using the weight sensor.

7. The laundry appliance of claim 1, wherein the laundry appliance further comprises a door sensor, and wherein detecting the activity trigger comprises determining that a door has been opened or closed using the door sensor.

8. The laundry appliance of claim 1, wherein the laundry appliance further comprises a microphone, and wherein detecting the activity trigger comprises detecting noise with the microphone.

9. The laundry appliance of claim 1, wherein the laundry appliance further comprises a proximity sensor, and wherein detecting the activity trigger comprises detecting motion near the laundry appliance using the proximity sensor.

10. The laundry appliance of claim 1, wherein identifying the occurrence of the predetermined condition or event comprises identifying the presence of an undesirable object within the chamber.

11. The laundry appliance of claim 1, wherein the controller is further configured to:
implement a responsive action in response to identifying the occurrence of the predetermined condition or event.

12. The laundry appliance of claim 11, wherein identifying the occurrence of the predetermined condition or event comprises determining that a laundry level has exceeded a predetermined threshold and implementing the responsive action comprises initiating an operating cycle of the laundry appliance.

13. The laundry appliance of claim 11, wherein implementing the responsive action comprises:
providing a user notification of the occurrence of the predetermined condition or event.

14. The laundry appliance of claim 13, further comprising:
a user interface panel, wherein the user notification is provided through the user interface panel.

15. The laundry appliance of claim 13, wherein the controller is in operative communication with a remote device through an external network, and wherein the user notification is provided through the remote device.

16. The laundry appliance of claim 1, wherein the machine learning image recognition process comprises at least one of a convolution neural network (“CNN”), a region-based convolution neural network (“R-CNN”), a deep belief network (“DBN”), a deep neural network (“DNN”), or a vision transformer (“ViT”) image recognition process.

17. The laundry appliance of claim 1, wherein the laundry appliance is a washer appliance, a dryer appliance, or a combination washer/dryer appliance.

18. A method of operating a laundry appliance, the laundry appliance comprising a tub positioned within a cabinet, a basket rotatably mounted within the tub and defining a chamber configured for receiving a load of clothes, and a camera assembly mounted within the cabinet in view of the basket, the method comprising:
detecting an activity trigger indicative of interaction with the laundry appliance;
obtaining one or more images of the chamber using the camera assembly in response to detecting the activity trigger; and
analyzing the one or more images using a machine learning image recognition process to identify the occurrence of a predetermined condition or event.

19. The method of claim 18, wherein the laundry appliance further comprises a user interface panel, and wherein the activity trigger comprises user interaction with the user interface panel.

20. The method of claim 18, further comprising:
implementing a responsive action in response to identifying the occurrence of the predetermined condition or event.
